(19) United States
(12) Patent Application Publication
(10) Pub. No.: US 2015/0046281 A1
(43) Pub. Date: Feb. 12, 2015

(54) PRODUCT SUGGESTIONS FOR RELATED ITEMS

(71) Applicants: Gurudatta Horantur Shivaswamy, Sunnyvale, CA (US); Gaurav Kukal, San Jose, CA (US); Arun Lakshminarayanan, San Jose, CA (US); Jaino Joseph, San Jose, CA (US)

(72) Inventors: Gurudatta Horantur Shivaswamy, Sunnyvale, CA (US); Gaurav Kukal, San Jose, CA (US); Arun Lakshminarayanan, San Jose, CA (US); Jaino Joseph, San Jose, CA (US)

(21) Appl. No.: 13/965,051

(22) Filed: Aug. 12, 2013

(51) Int. Cl. G06Q 30/06

(52) U.S. Cl. CPC G06Q 30/0631
USPC 705/26.7

(57) ABSTRACT

Techniques for providing improved product suggestions for related items are described. According to various embodiments, a product listing webpage associated with a retailer website that describes a specific product may be crawled, the specific product being included in a product inventory of the retailer website. Thereafter, product relations information associated with the specific product may be identified in the product listing webpage, the product relations information describing a group of one or more additional products in the product inventory having a particular relationship with the specific product. The product relations information may then be transposed to a second product inventory associated with a second retailer.

### TECHNICAL FIELD

The present application relates generally to data processing systems and, in one specific example, to techniques for providing improved product suggestions for related items.

### BACKGROUND

Conventional retailer websites allow shoppers to browse through a wide variety of products available for sale online. Each retailer website typically hosts multiple product listing webpages that offer various products for sale. Each retailer website generally maintains its own inventory of products.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 illustrates an exemplary portion of a product listing webpage, according to various embodiments;

FIG. 5 illustrates an example of product relationship keyword information, according to various exemplary embodiments;

FIG. 6 illustrates an example of a data table storing product relationship information, according to various embodiments;

FIG. 7 illustrates an example of product inventory information, according to various embodiments;

FIG. 8 is a flowchart illustrating an example method, according to various embodiments;

FIG. 9A illustrates an aspect of a technique of matching product items from one product inventory to product items from another product inventory, according to various embodiments;

FIG. 9B illustrates an example of a data table storing transposed product relationship information, according to various embodiments;

FIG. 10 illustrates an example of a product listing webpage that includes transposed product relationship information, according to various exemplary embodiments;

FIG. 11 is a flowchart illustrating an example method, according to various embodiments;

FIG. 12 illustrates examples of various social communications, according to various embodiments;

FIG. 13 illustrates examples of social communication relationship keywords, according to various embodiments;

FIG. 14 illustrates an example of product relationship information, according to various embodiments;

FIG. 15 illustrates an example of a product listing webpage, according to various embodiments;

FIG. 16 is a flowchart illustrating an example method, according to various embodiments;

FIG. 17 is a schematic diagram illustrating a technique for matching products from different product inventories, according to various embodiments; and

FIG. 18 is a diagrammatic representation of a machine in the example form of a computer system within which a set of instructions, for causing the machine to perform any one or more of the methodologies discussed herein, may be executed.

### DETAILED DESCRIPTION

Example methods and systems for providing improved product suggestions for related items are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a system crawls retailer websites for product relations information for products in the product inventories of the retailer websites, and infers product relations for products in another product inventory based on the crawled information. For example, a product page for product P1 on a retail website of the Competitor Corporation may list other related products (e.g., “people who viewed P1 also viewed P2-P5”, “people who bought P1 also brought P6-P10”, “see accessories P11-P15 for P1”, etc., where P1-P15 are product IDs in the Competitor Corporation's namespace). Based on this, the system may infer that P1 has a relationship R1 with P2-P5, relationship R2 with P6-P10, relationship R3 with P11-P15, and so on.

This external product relations information may then be transposed to a second retail website by finding the equivalent products of the second retailer (using deterministic product matching techniques) and by inferring the appropriate relationships between the matching products of the second retailer. Thus, the system can leverage vast amounts of product relations information already existing on the web in order to improve a retailer's ability to recommend related products for a given product. At a high level, the system allows a retailer to track the affinity between various products across the web, which may improve the product search experience for the user, and may ultimately lead to higher rates of conversion.

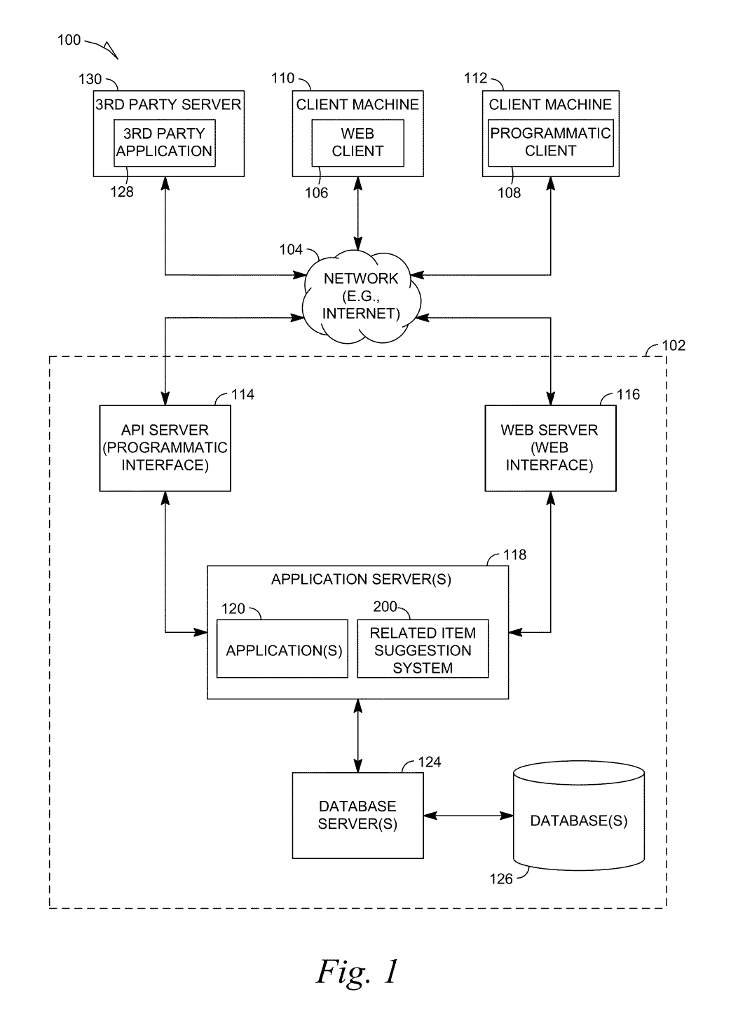

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

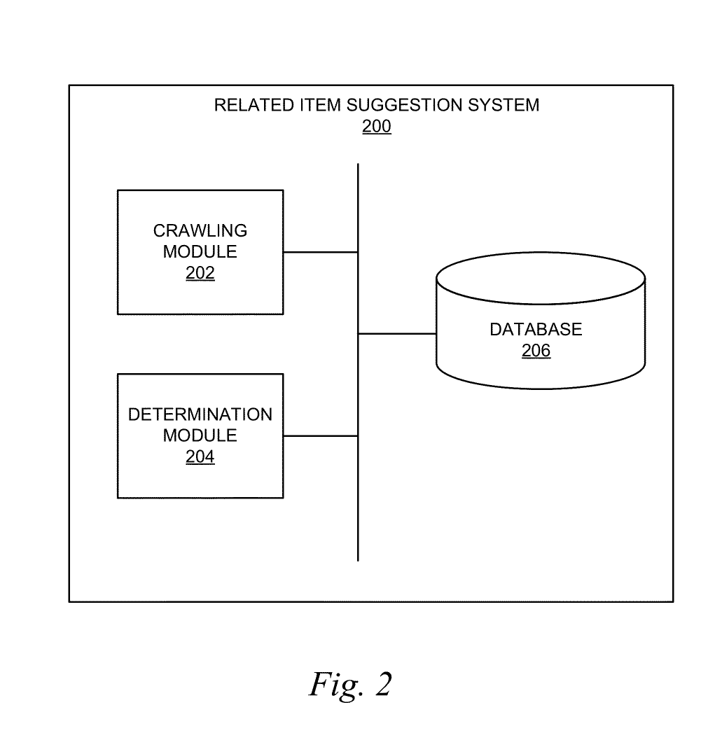

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 host what is generally referred to herein a related item suggestion system 200. The related item suggestion system 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a related item suggestion system 200 includes a crawling module 202, a determination module 204, and a database 206. The modules of the related item suggestion system 200 may be implemented on or executed by a single device such as a related item suggestion device, or on separate devices interconnected via a network. The aforementioned related item suggestion device may be, for example, one of the client machines (e.g. 110, 112) or application server(s) 118 illustrated in FIG. 1.

As described in more detail below, the crawling module 202 is configured to crawl a product listing webpage associated with a marketplace website, e-commerce website, and/or retailer website (e.g., Amazon®, eBay®, Google® Offers, etc.), where the product listing webpage describes a specific product included in a product inventory of the retailer website. The crawling module 202 is also configured to identify, in the crawled product listing webpage describing the specific product, product relations information describing additional products in the product inventory of the retailer website that are related to the specific product. For example, the product relations information may describe a group of additional products that tend to be purchased by users that purchased the specific product, or a group of additional products that tend to be viewed by users that viewed the specific product, or a group of additional products that tend to be purchased by users that viewed the specific product, or a group of products that are accessories for the specific product, and so on.

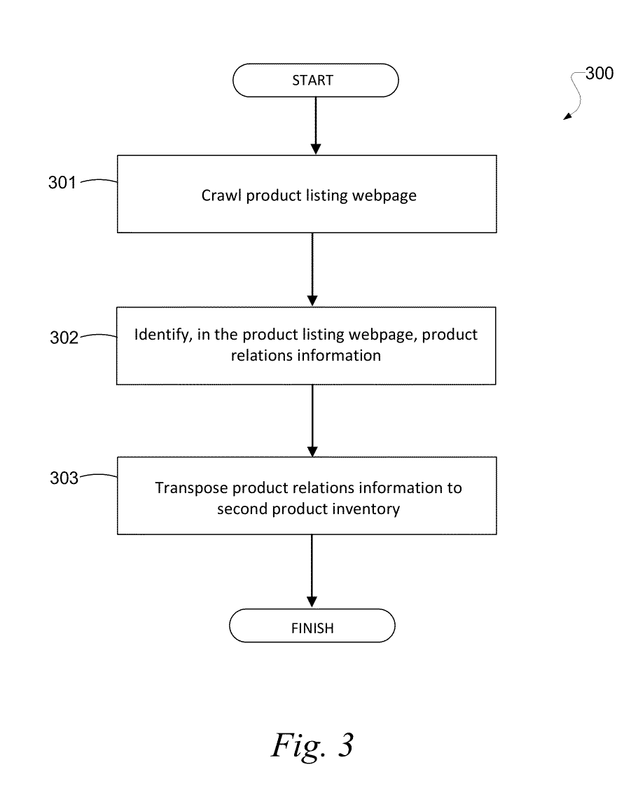

Thereafter, the determination module 204 (also referred to herein as a transposition module 204) is configured to transpose such product relations information to a second product inventory associated with a second retailer website (e.g., Amazon®, eBay®, Google® Offers, etc.). For example, the determination module 204 may transpose the product relations information by: identifying a second product in the second product inventory that matches the specific product from the first product inventory; identifying a second group of additional products in the second product inventory that matches the first group of additional products from the first product inventory; and inferring that the second product has a given relationship with the second group of additional products, based on the products relations information that indicates that the first product has the given relationship with the first group of additional products. The operation of the aforementioned modules of the related item suggestion system 200 will now be described in greater detail in conjunction with FIG. 3.

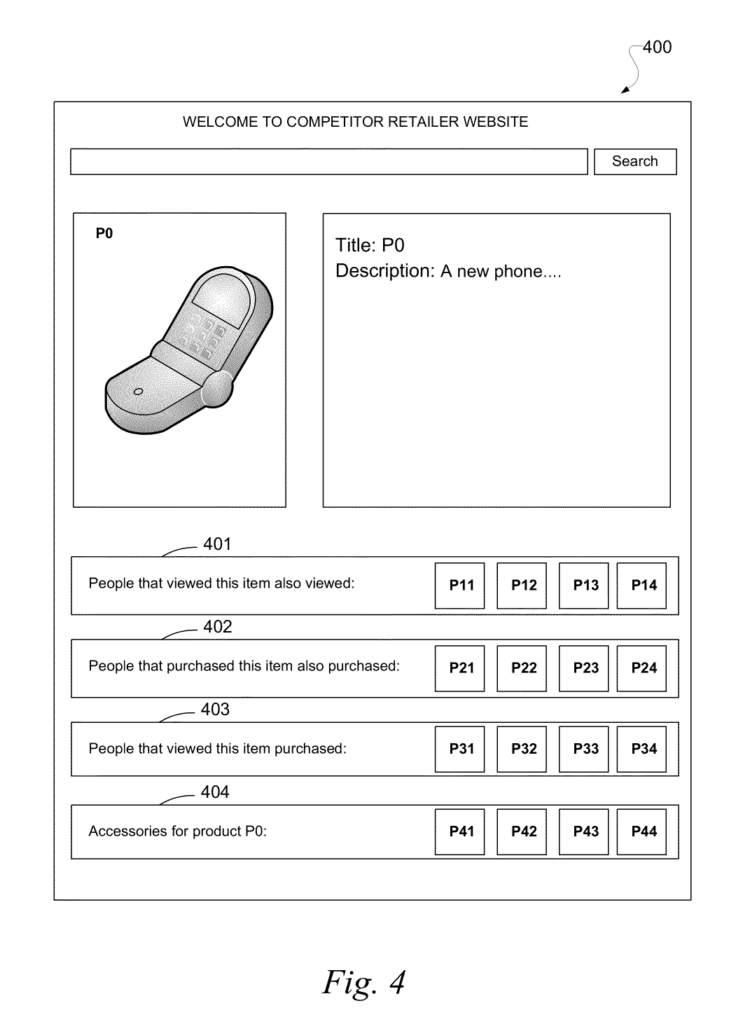

FIG. 3 is a flowchart illustrating an example method 300, according to various exemplary embodiments. The method 300 may be performed at least in part by, for example, the related item suggestion system 200 illustrated in FIG. 2 (or an apparatus having similar modules, such as client machines 110 and 112 or application server 118 illustrated in FIG. 1). In operation 301, the crawling module 202 crawls various product listing webpages associated with a retailer website (e.g., Amazon®, Google® Offers, etc.). Each of the product listing webpages on a retailer website may describe a specific product offered for sale on the retailer website, where the specific product may be any type of product or service. For example, FIG. 4 illustrates an example of a product listing webpage 400 of an exemplary retailer website of a retailer entitled “Competitor”. The product listing webpage 400 describes a particular product P0 (e.g., a smartphone) for sale on the Competitor retailer website, and includes an image of the product P0 and various descriptive information about the product P0 (e.g., title, description, attributes, characteristics, properties, specifications, price, location, etc.). The crawling module 202 may crawl the product listing pages of a retailer website using any techniques known by those skilled in the art. For example, web crawling may include visiting a known webpage, gathering information from the webpage, detecting reference links (e.g., Uniform Resource Locators or URLs) to additional webpages provided on the webpage, visiting the additional webpages pages, repeating the process of gathering information and detecting reference links on each of the additional webpages, and so on. Methods and techniques for crawling publicly accessible Web pages and websites are well-known, and will not be described in detail herein in order to avoid occluding various aspects of this disclosure.

Referring back to the method 300 in FIG. 3, after the crawling module 202 crawls various product listing pages associated with a retailer website in operation 301, the crawling module 202 identifies product relations information included in each of the crawled product listing webpages. As described herein, products relations information refers to any information that indicates that a given product has a particular relationship with at least one other product. For example, a product listing webpage associated with the retailer website may describe a given product for sale on the retailer website, and such product listing webpages typically also include product relations information describing additional products that are related to the given product in some way. For example, the product listing webpage 400 includes portions 401-404 that describe various products that are related in some way to the specific product P0. For example, the portion 401 of the webpage 400 indicates that people that viewed product P0 also viewed products P11-P14, while portion 402 of the webpage 400 indicates that people that viewed product P0 also purchased products P21-P24, while portion 403 indicates that people that viewed product P0 also purchased products P31-P34, while portion 404 indicates that products P41-P44 are accessories to the product P0, and so on.

Accordingly, the information included in portions 401-404 corresponds to product relations information. For example, portion 401 describes product P0 having a particular relationship “R1” with products P11-P14, where the relationship R1 may be defined as follows: if product X has a relationship R1 with product Y, then people who viewed product X tended to view the product Y. As another example, portion 402 describes product P0 having another relationship “R2” with products P21-P24, where the relationship R2 may be defined as follows: if product X has a relationship R2 with product Y, then people who purchased the product X tended to purchase the product Y. As another example, portion 403 describes product P0 having a relationship “R3” with products P31-P34, where the relationship R3 may be defined as follows: if product X has a relationship R3 with product Y, then this may mean that people who viewed product X tended to purchase product Y. As another example, portion 404 describes product P0 having a relationship “R4” with products P41-P44, where the relationship R4 may be defined as follows: if product X has a relationship R1 with product Y, then product Y is an accessory of product X.

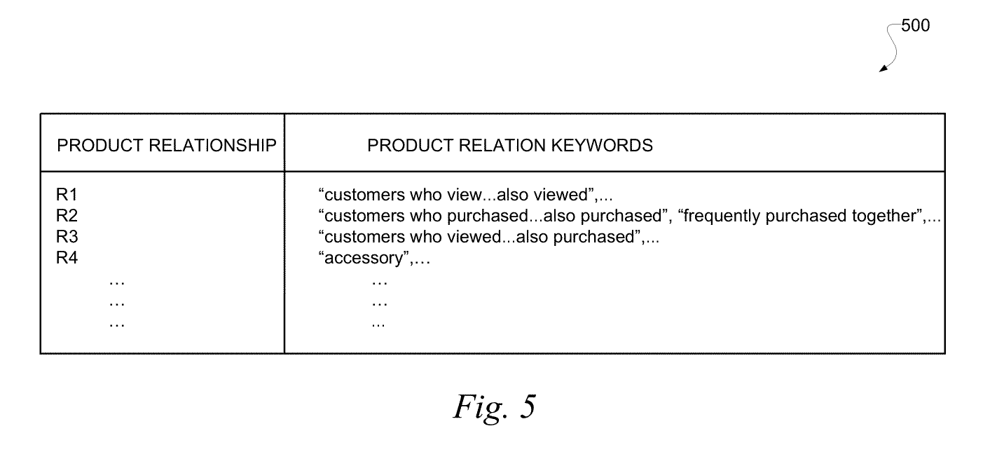

The crawling module 202 may detect the product relations information included in product listing webpages using various techniques. In some embodiments, the crawling module 202 may crawl all the data included in the product listing webpage, and identify keywords, phrases, or language indicating that a group of one or more products have a certain relationship with the main product described in the product listing webpage. For example, the crawling module 202 may access product relations keyword information 500 illustrated in FIG. 5 that identifies various product relationships R1, R2, R3, etc., as described above, where the product relations keyword information 500 also identifies keywords, phrases, or language that correlates with each of the relationships. Thus, the determination module 204 may access the product relations keyword information 500 that lists known product relations keywords associated with various relationships, and the determination module 204 may attempt to identify one or more of these keywords displayed in proximity to a list of one or more products in a product listing webpage, in order to identify the product relations information in the product listing webpage.

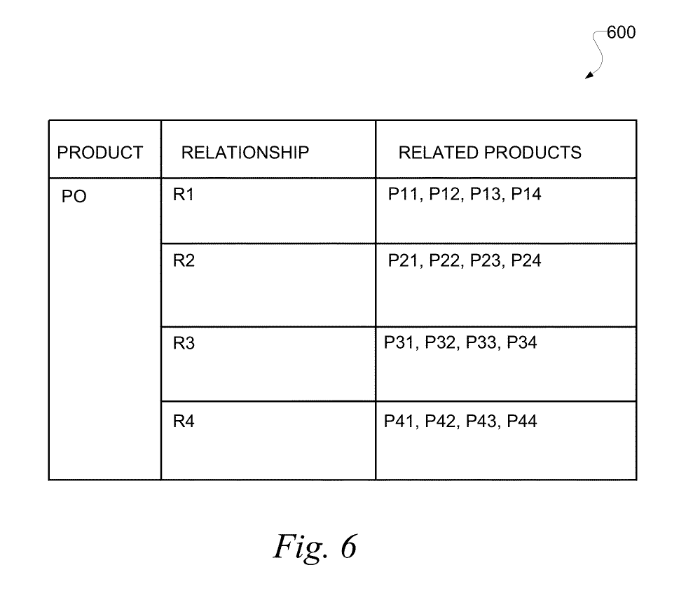

In some embodiments, after the crawling module 202 identifies the product relations information in a product listing page, the crawling module 202 may store the product relations information in a data table or data structure, such as the exemplary data table 600 illustrated in FIG. 6, which identifies a particular product (e.g., product P0 illustrated in FIG. 4) and various relationships (e.g., R1, R2, R3, etc.), and that also identifies, for each of the relationships, a group of related products having that relationship with the particular product P0. For example, the information in the data table 600 indicates that the products P11-P14 have the relationship R1 with the product P0, whereas the products P21-P24 have the relationship R2 with the product P0, and so on. The data table 600 may be stored locally at, for example, the database 206 illustrated in FIG. 2, or may be stored remotely at a database, data repository, storage server, etc., that is accessible by the related item suggestion system 200 via a network (e.g., the Internet).

While the exemplary embodiments above describe various examples of relationships, it is understood that the embodiments herein are applicable to any type of relationship between products, such as products being related to each other because they are often bundled together, or because they are similar, or because they are from the same/similar manufacturer, or because they fit together or they are compatible with each other, or because they do not fit together or they are not compatible with each other, or because they are frequently mentioned together, or because they are frequently confused with each other, or because one is thought to be a replacement for the other, and so on.

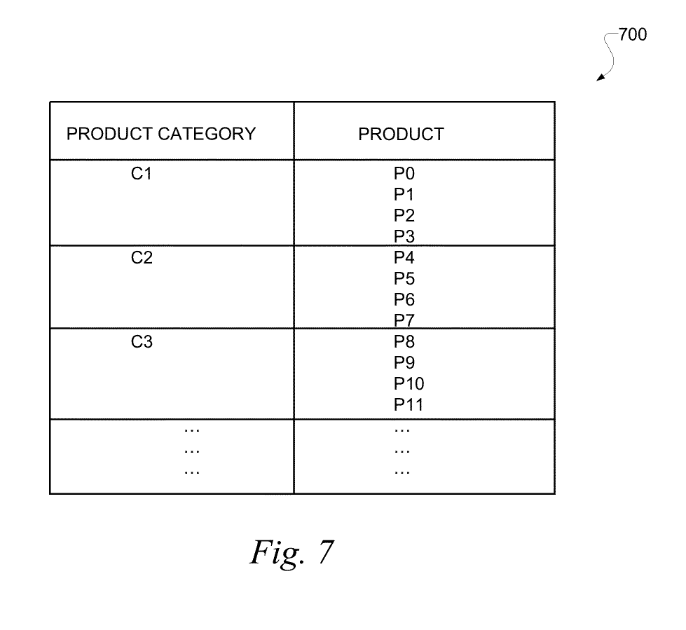

According to various exemplary embodiments, the products P0 and P11-P44 may be included in a product inventory associated with the Competitor retailer website, where the product inventory may be defined or specified in a product catalog or product classification directory associated with the Competitor retailer website. For example, FIG. 7 illustrates exemplary product inventory information (e.g., a product catalog or product classification directory) maintained by the Competitor retailer website, which identifies various product categories (e.g., C1, C2, C3, etc.) and various products (e.g., P0-P11, etc.) associated with each of these product categories, in accordance with the product inventory of the Competitor retailer website. As described in more detail below, the names of each of the products P0-P4 and the names of each of the product categories C1-C3 may be unique to the Competitor retailer website. In other words, P0 may correspond to a name of a product (e.g. a smartphone) based on the namespace of the Competitor retailer website, whereas another retailer website (e.g., eBay®) may refer to that same product using a different name based on the namespace of the other retailer website. Similarly, each of the products P11-P44 described in the product listing webpage 400 may be referred to by other names in the namespace or nomenclature of different retailer websites. Accordingly, the product inventory information 700 illustrated in FIG. 7 may be unique to the Competitor retailer website, and different product retailers (e.g., eBay®, Amazon®, Google® Offers, etc.) may maintain their own distinct product inventories. Thus, while the underlying products in the product inventories of the various retailer websites may overlap, certain products and certain product categories may be referred to with different names by different retailers, and it is possible that certain products may be grouped into different product categories by the different retailers.

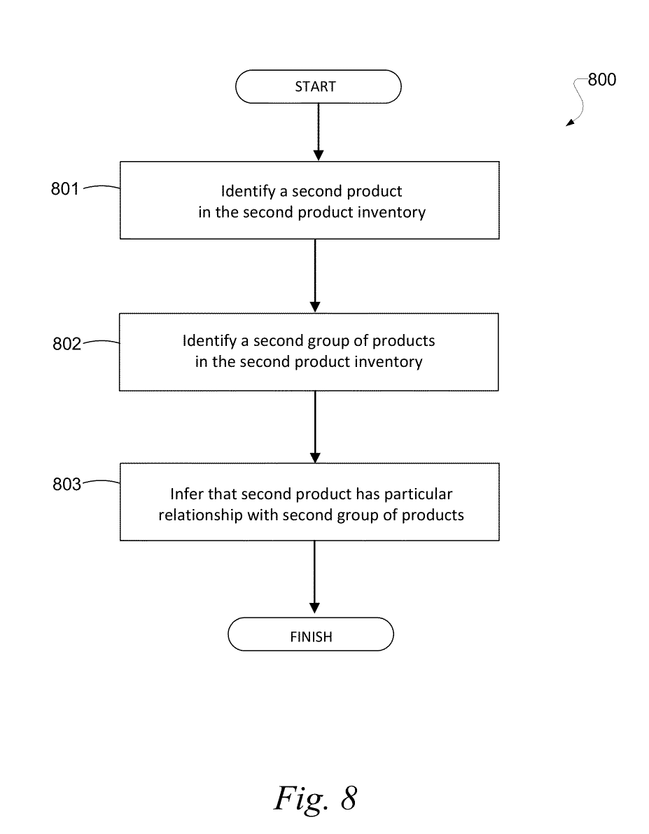

Referring back to the method 300 in FIG. 3, in operation 303, the determination module 204 transposes the product relations information identified in operation 302 to another product inventory associated with another retailer website. For example, as described above, each retailer website (e.g., Amazon®, eBay®, Google® Offers, etc.) may be associated with the particular product inventory, and each of the retailer websites may refer to products with different names. Accordingly, the determination module 204 is configured to transpose the product relations information (e.g., see FIG. 6) associated with the Competitor retailer website to another product inventory associated with another website. For example, based on information that product P0 has relationship R1 with products P11-P14 (where products P0 and products P11-P14 are defined in the namespace of the Competitor product inventory), the determination module 204 may transpose this information to determine that product eP0 has relationship R1 with products eP11-eP14, where eP0 and eP11-eP14 are defined in the namespace of another product inventory such as the eBay® product inventory). Operation 303 in FIG. 3 will now be described in greater detail in conjunction with FIG. 8.

FIG. 8 is a flowchart illustrating an example method 800, consistent with various embodiments described above. The method 800 may be performed at least in part by, for example, the related item suggestion system 200 illustrated in FIG. 2 (or an apparatus having similar modules, such as client machines 110 and 112 or application server 118 illustrated in FIG. 1). In operation 801, the determination module 204 identifies a second product in the second product inventory that matches the specific product in the product listing webpage that was crawled in operation 301. For example, the determination module 204 identifies a product eP0 in the product inventory of eBay® that matches the product P0 in the product inventory of the Competitor retailer website (see FIG. 4).

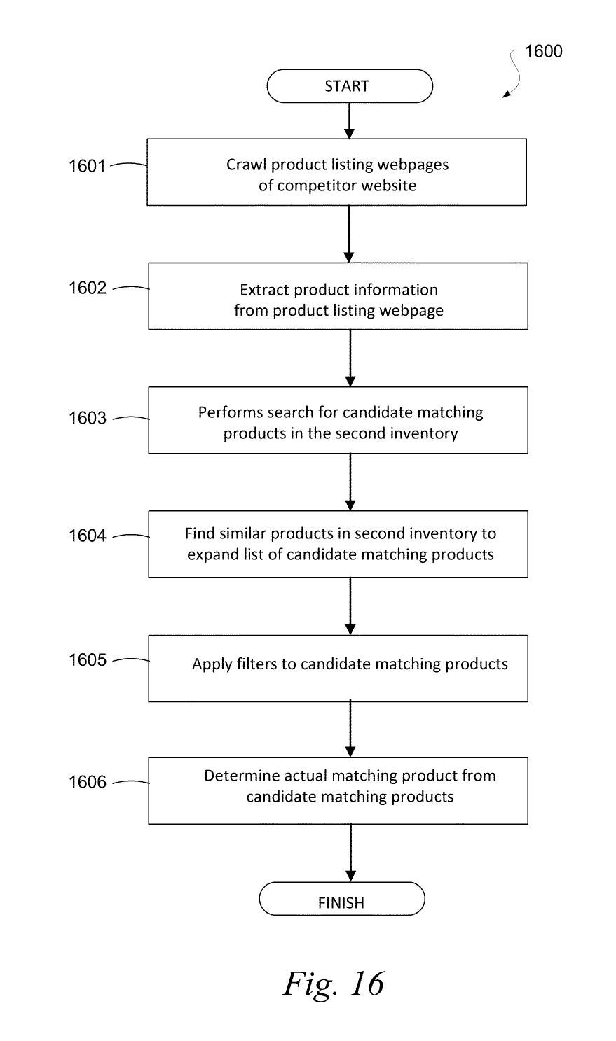

The determination module 204 may identify the matching product by analyzing and extracting various attributes associated with the product P0 from the product listing webpage 400 or other online sources, and attempting to find a product in the second product inventory having attributes matching the extracted attributes. For example, in some embodiments, the determination module 204 may identify a matching product eP0 in the second product inventory by determining that the particular product P0 and the second product eP0 have the same unique product identifier (e.g., a universal product code (UPC), an international article number (IAN), an international standard book number (ISBN), a global trade item number (GTIN), etc.). In some embodiments, the determination module 204 may identify a matching product eP0 in the second product inventory by determining that the particular product P0 and the second product eP0 have a similar brand name and the same manufacturer part number (MPN). In some embodiments, the determination module 204 may identify a matching product eP0 in the second product inventory by determining that the particular product P0 and the second product eP0 have a similar product title. In some embodiments, the determination module 204 may identify a matching product eP0 in the second product inventory by determining that the particular product P0 and the second product eP0 have a similar product image, using any kind of image comparison process or image recognition process known to those skilled in the art. In some embodiments, the determination module 204 may identify a matching product eP0 in the second product inventory by determining that the particular product P0 and the second product eP0 have similar description, tags, specifications, characteristics, properties, prices, etc. Thus, the second product is identified by determining that the particular product and the second product have similar attributes, where the attributes may be extracted from product listing webpages, product catalogs, product classification directories, other online sources, and so on. Examples of techniques for matching products from different product inventories are described below in conjunction with FIG. 16.

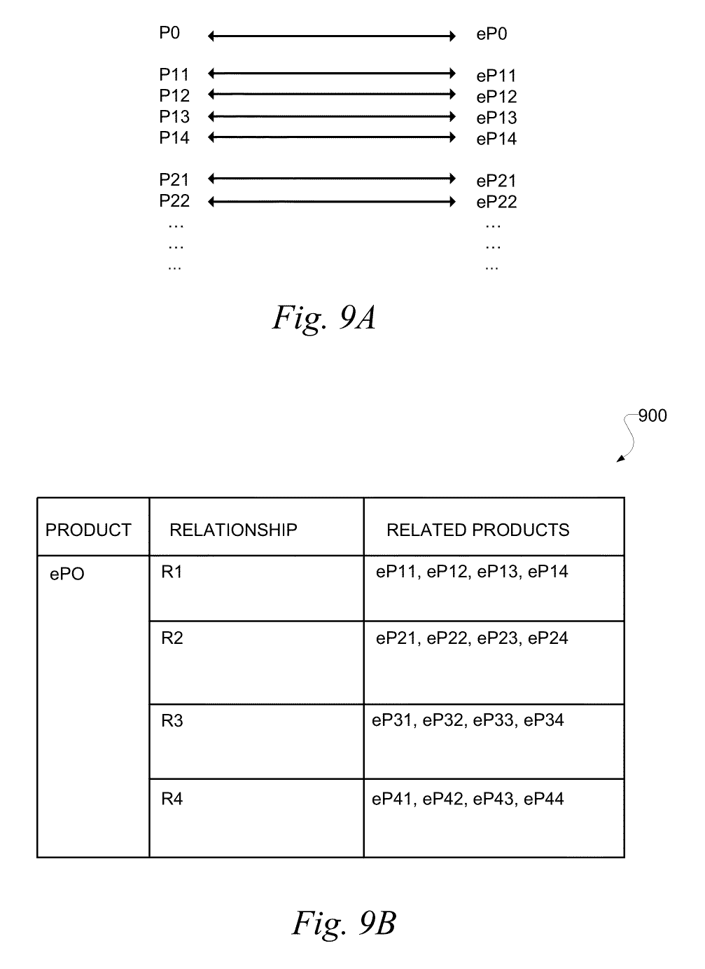

In operation 802 in FIG. 8, the determination module 204 identifies a second group of products in the second product inventory that matches the group of products described in the product relations information (that was identified in operation 302 in FIG. 3). For example, for each of the products P11-P14 having the relationship R1 with the product P0 (see the product relations information in FIG. 6), the determination module 204 may identify matching products eP11-eP14 that match the products P11-P14. Similarly, the determination module 204 may identify matching products eP21-eP24 that match the products P21-P24, and so on. The determination module 204 may utilize any of the techniques described above or any other known techniques to discover the matching products. Thus, for each of the products identified in the product listing webpage 400 associated with a given retailer website (e.g., Competitor retailer website), the determination module 204 is configured to identify matching products in the product inventory of another retailer website, as illustrated in FIG. 9A.

In operation 803 in FIG. 8, the determination module 204 infers that the product eP0 in the second product inventory (that matches the product P0 in the first product inventory) has the particular relationship R1 with the group of products eP11-eP14 in the second product inventory (that match the products P11-P14 in the first product inventory). Similarly, the determination module 204 infers that the product eP0 in the second product inventory (that matches the product P0 in the first product inventory) has the particular relationship R2 with the group of products eP21-eP24 in the second product inventory (that match the products P21-P24 in the first product inventory), and so on. Accordingly, the determination module 204 transposes the product relations information illustrated in FIG. 6 associated with a product inventory of a retailer website to a second product inventory of a second retailer website. The determination module 204 may store the transposed product relations information in a data structure or data table 900 as illustrated in FIG. 9B. The data structure 900 may be stored locally at, for example, the database 206 illustrated in FIG. 2, or may be stored remotely at a database, data repository, storage server, etc., that is accessible by the related item suggestion system 200 via a network (e.g., the Internet).

The determination module 204 may repeat this operation for all the product relations information included in all product listing webpages that may be crawled by the crawling module 202. Accordingly, product relations information for each product in the inventory of the Competitor retailer website may be transposed to, for example, all the corresponding products in the product inventory of the second retailer website.

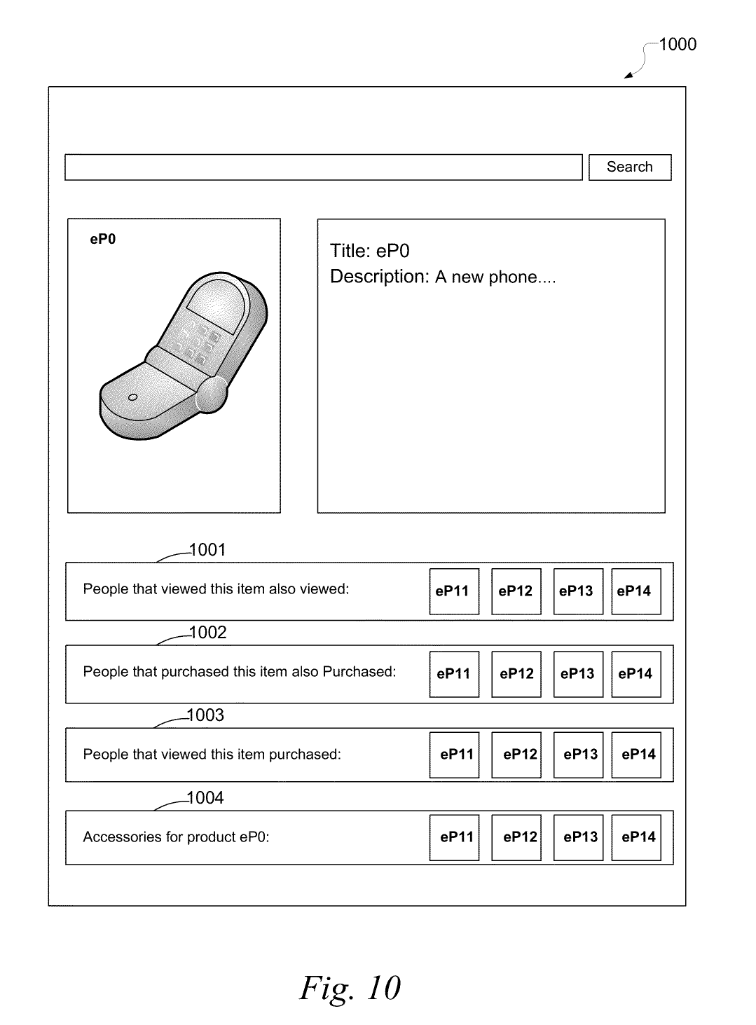

According to various exemplary embodiments, after the determination module 204 transposes the product relations information to a second product inventory, the determination module 204 may use the transposed product relations information to provide a recommendation for related items to a user. For example, in some embodiments, the determination module 204 may receive (or detect) a request from a user to view a product listing webpage of a retailer website (e.g., eBay®) that is associated with a particular product (e.g., product eP0). For example, such a user request may be received when the user specifies the name of the product eP0 in a search query user interface element of the retailer website, or when the user selects the product eP0 from a list of search results, and so on. In response, the determination module 204 may display a product listing webpage for the product eP0, wherein the product listing webpage identifies the various related product items, such as product items eP11-eP14 having the relationship R1 with the product eP0, or product items eP21-eP24 having the relationship R2 with the product eP0, and so on. For example, FIG. 10 illustrates an exemplary product listing webpage 1000 hosted by a retailer website, where the product listing webpage 1000 describes the product eP0 and includes webpage portions 1001-1004 identifying various related product items in the product inventory of the retailer website. Thus, the product relations information included in the portions 1001-1004 is transposed from the product relations information 401-404 from the Competitor website illustrated in FIG. 4.

In some embodiments, the determination module 204 may cause product relations information to be displayed on a device such as a mobile device (e.g., smartphone or tablet computing device). For example, the determination module 204 may cause the entire product listing webpage 1000 to be displayed on a device, or the determination module 204 may cause one or more of the portions 1001-1004 of product relations information to be displayed on the device. In some embodiments, the determination module 204 may include product relations information in a notification (e.g., an e-mail or a text message) transmitted to a user of a retailer website. For example, the notification may include the product listing webpage 1000 or a reference link (e.g., uniform resource indicator (URI) or uniform resource locator (URL)) to the product listing webpage 1000. Alternatively, the notification may include one or more portions 1001-1004 of product relations information or links there to. The aforementioned notification may correspond to a “browse but did not buy” e-mail that identifies the product eP0 as an item that the user browsed or viewed but did not purchase, as well as identifying various related items based on the transposed product relations information 1001-1004. Alternatively, the aforementioned notification may identify the product eP0 as an item that the user may be interested in (based on an analysis of similar items that were viewed by the user or based on a user preference profile), and the notification may identify various related items based on the transposed product relations information 1001-1004.

While various embodiments herein refer to product relations information being included in crawled product listing webpages associated with retailer websites, it is understood that such product relations information may be obtained from other online sources that may not necessarily correspond to product listing webpages. For example, product relations information may be included in a homepage, catalog page, search results page, demonstration/tour/tutorial page, content/news/status feed, advertisements, notifications (e.g., e-mails, text messages, instant messages, etc.) and various other types of content that may or may not be associated with a retailer website. Accordingly, the crawling module 202 is configured to crawl any of these online sources in order to identify product relations information, consistent with various embodiments described herein.

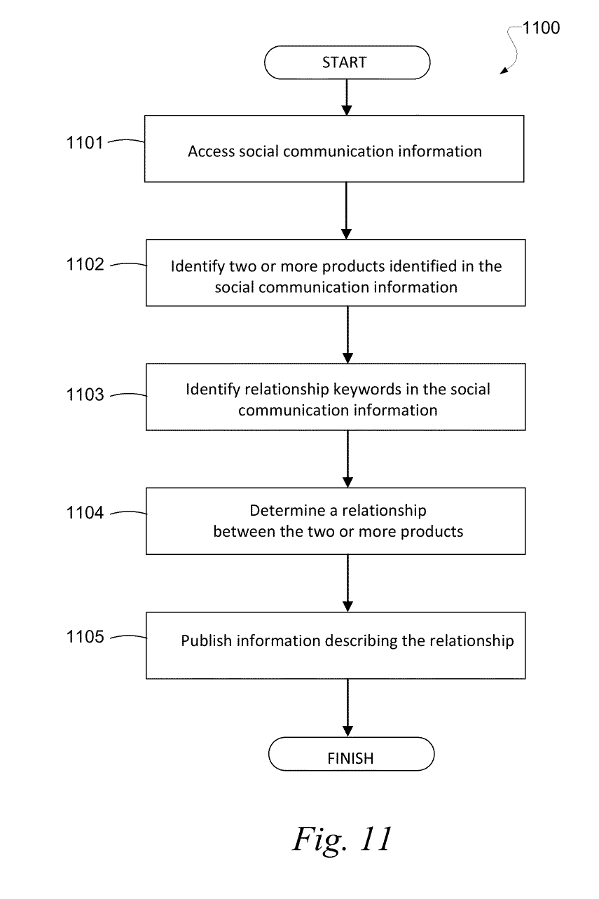

Turning now to FIGS. 11-15, the related item suggestion system 200 may, according to various exemplary embodiments, mine social communications (e.g., private communications between buyers and sellers, public communications on social networks) in order to determine relationships between products.

For example, the related item suggestion system 200 may mine questions and answers between buyers and sellers on a retailer website (e.g., eBay®) in order to detect communications that describe various products (e.g., questions such as “Does A fit with B?”, “Is A compatible with B?”, “Will A work with B?”, “Is A the same as B?”, and so on). Accordingly, based on these communications, the system 200 may infer relations between products, such as “A fits with B”, “A is compatible with B”, “A is the same as B”, “A is frequently mentioned with B”, “A is often confused with B”, etc.

This information can be used by the related item suggestion system 200 to provide buyers with recommendations for similar product items (e.g., “This product is compatible/fits/works with ABC”), provide warnings to a buyer (e.g., “This product is often confused with XYZ”), guide sellers when generating item listings, provide a list of FAQs (Frequently Asked Questions) for a given product item, provide an interface to buyers to answer buyer questions directly, provide advice to a seller for answering questions from buyers, and so on.

For example, FIG. 11 is a flowchart illustrating an example method 1100, consistent with various embodiments described above. The method 1100 may be performed at least in part by, for example, the related item suggestion system 200 illustrated in FIG. 2 (or an apparatus having similar modules, such as client machines 110 and 112 or application server 118 illustrated in FIG. 1). In operation 1101, the crawling module 202 accesses social communication information, such as private communications between buyers and sellers on a retailer website (e.g., eBay®), or communications posted on social networking services such as Facebook® and LinkedIn® (e.g., the social networking homepages of companies, newsfeeds, etc.), or other online sources (e.g., webpages, forums, billboards, customer service pages, etc.), and so on. The crawling module 202 may access this social communication information from a database, such as a database that is configured to store communications associated with a retailer website (e.g., eBay®) or social network service (e.g., Facebook®, LinkedIn®, etc.). For example, the social communication information may be stored locally at, for example, the database 206 illustrated in FIG. 2, or may be stored remotely at a database, data repository, storage server, etc., that is accessible by the related item suggestion system 200 via a network (e.g., the Internet). Alternatively, the crawling module 202 may crawl webpages, such as webpages hosted by a social network service or webpages hosted by a particular company, in order to obtain the aforementioned social communication information.

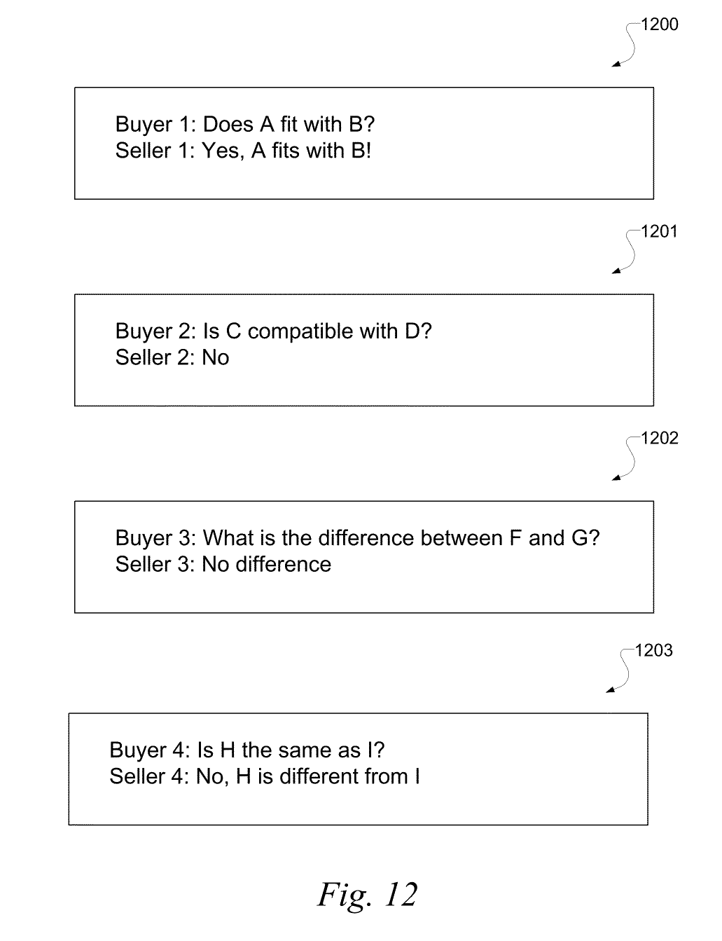

FIG. 12 illustrates examples of specific instances of social communications between buyers and sellers on a retailer website (e.g., eBay.com). As illustrated in FIG. 12, each of the social communications 1200-1203 corresponds to a dialogue between a buyer and seller. For example, when a buyer reviews a product listing webpage, such a page typically includes a feature for allowing the buyer to communicate with the seller of the product in the product listing webpage, and such communications may be stored in a database as described above.

Referring back to FIG. 11, in operation 1102, the determination module 204 identifies two or more products in a social communication. For example, the determination module 204 may refer to product inventory information (e.g., see FIG. 7) identifying various products for sale on a retailer website, and the determination module 204 may perform a keyword search on the textual information in various social communications in order to detect particular products described therein. For example, with reference to the social communication 1200 in FIG. 12, the determination module 204 may identify that products A and B are described. Similarly, the determination module 204 may identify products C and D in social communication 1201, products F and G in social communication 1202, and products H and I in social communication 1203.

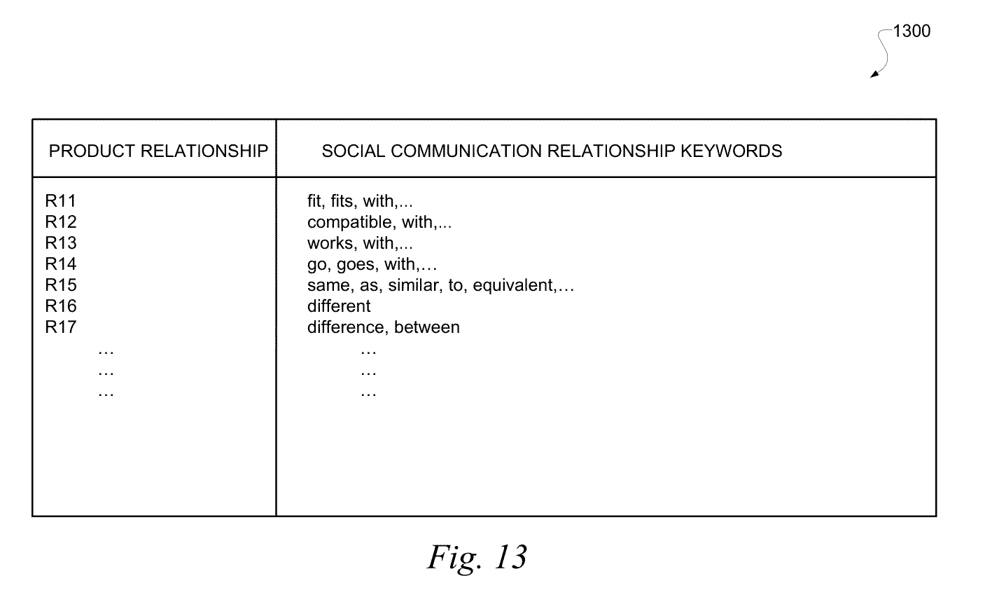

Referring back to FIG. 11, in operation 1103, the determination module 204 may identify one or more relationship keywords in the social communication information. For example, the determination module 204 may access social communication relationship keyword information 1300 illustrated in FIG. 13, which identifies various known relationship keywords associated with various relationships R11-R17. Accordingly, the determination module 204 may perform a keyword search on the textual information in various social communications in order to detect any of the social communication relationship keywords therein. For example, with reference to the social communication 1200 in FIG. 12, the determination module 204 may identify the social communication relationship keyword “fit”. Similarly, the determination module 204 may identify the social communication relationship keyword “compatible” in the social communication 1201, and the social communication relationship keywords “difference between” in social communication 1202, and the social communication relationship keywords “same as” in the social communication 1203, and so on.

In operation 1104 in FIG. 11, the determination module 204 determines that the products described in a social communication (as determined in operation 1102) have a particular relationship with each other, based in part on the relationship keywords identified in operation 1103. For example, with reference to the social communication 1200 illustrated in FIG. 12, the determination module 204 identified that products A and B are described therein (in operation 1102) and that the keyword “fit” is described therein (in operation 1103). Moreover, the determination module 204 may determine that the response from the seller included an affirmative term (e.g., yes, correct, right, indeed, etc.). Thus, the determination module 204 may determine that product A and product B have relationship R11 with each other (see FIG. 13), where relationship R11 may be, for example, that product A fits/works with/is compatible with product B. As another example, with reference to the social communication 1201 illustrated in FIG. 12, the determination module 204 identified that products C and D are described therein (in operation 1102) and that the keyword “compatible” is described therein (in operation 1103). Moreover, the determination module 204 may determine that the response from the seller included a negative term (e.g., no, incorrect, wrong, etc.). Thus, the determination module 204 may determine that product C and product D have the inverse of relationship R12 with each other (see FIG. 13), where relationship R12 may be, for example, that product C fits/works with/is compatible with product D (and thus the inverse of relationship R12 is that product C does not fit with, does not work with, or is not compatible with product D). The determination module 204 may employ any known technique of natural language processing, semantic processing, n-gram modeling, token processing, and so on, in order to determine the relationship between two or more products described in a social communication, based on the language in such a social communication.

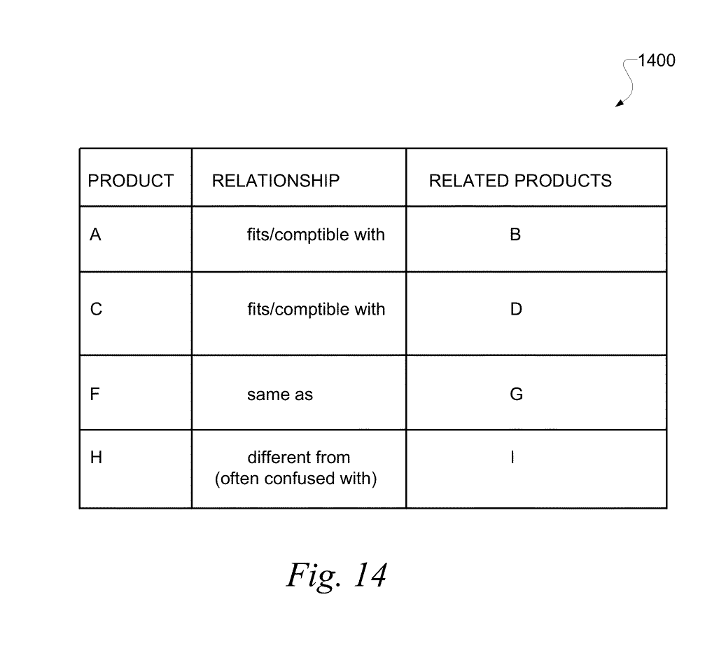

Accordingly, the determination module 204 may generate relationship information 1400 illustrated in FIG. 14 that identifies various products and relationships between those products as determined from the mined social communications. The determination module 204 may employ various statistical analysis techniques in order to generate relationship information 1400. For example, before determining that product A has relationship Rx with product B, it is possible that the determination module 204 must first determine that the majority of communications identifying product A and product B support the determination of the relationship Rx, and/or that at least a minimum threshold number of communications identifying product A and product B support the determination of the relationship Rx, and so on.

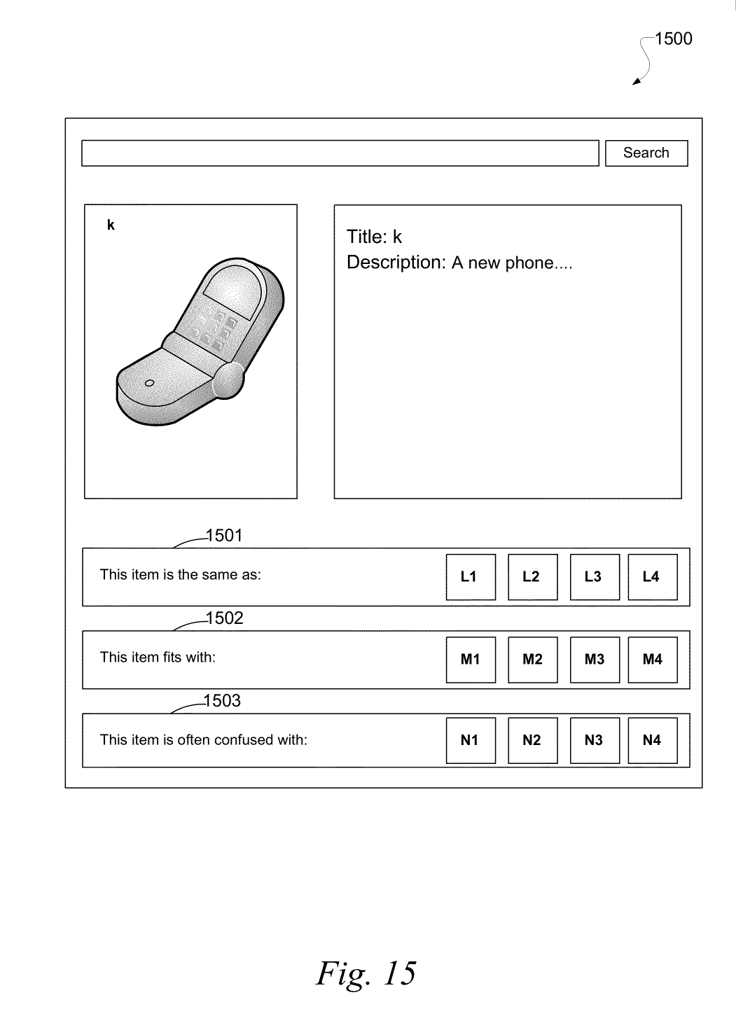

In operation 1105 (which is an optional operation in the method 1100), the determination module 204 provides the relationship information determined in operation 1104 to a user. For example, if the user transmits a request to view a product listing page associated with the particular item K, the determination module 204 may display the product listing webpage for item K and include information identifying various items that are related to item K in some way, as determined by the determination module 204 based on the method described in FIG. 11. For example, FIG. 15 illustrates an example of a product listing page 1700 for the item K that includes portions 1501-1503 identifying other items that are related to item K in some way, thereby providing buyers with recommendations for similar product items (e.g., “This item is the same as . . . ”, “This product is compatible/fits/works with . . . ”), as well as providing warnings to a buyer (e.g., “This product is often confused with . . . ”), and so on.

The determination module 204 may also include such relationship information in a frequently asked questions (FAQ) webpage, such as a FAQ webpage associated with one or more products on a retailer website (e.g., eBay®). The determination module 204 may also provide an interface to buyers to answer buyer questions directly, such as a help page, wherein if the buyer types in a query such as “does A fit with B”, the determination module 204 may access the information 1400 in FIG. 14 in order to automatically provide the buyer with a response. Similarly, the determination module 204 may provide an interface to sellers or customer service personnel to provide advice for answering questions from a buyer (e.g., when a customer service personnel or seller receives a message from a buyer such as “does A fit with B”, the determination module 204 may automatically generate a draft response into a response message field, based on information 1400 in FIG. 14). The determination module 204 may also utilize such relationship information to guide sellers when they are generating item listings (e.g., by pre-filling the appropriate relationship information 1501-1503 into a draft product listing webpage after a seller specifies the product item they are selling).

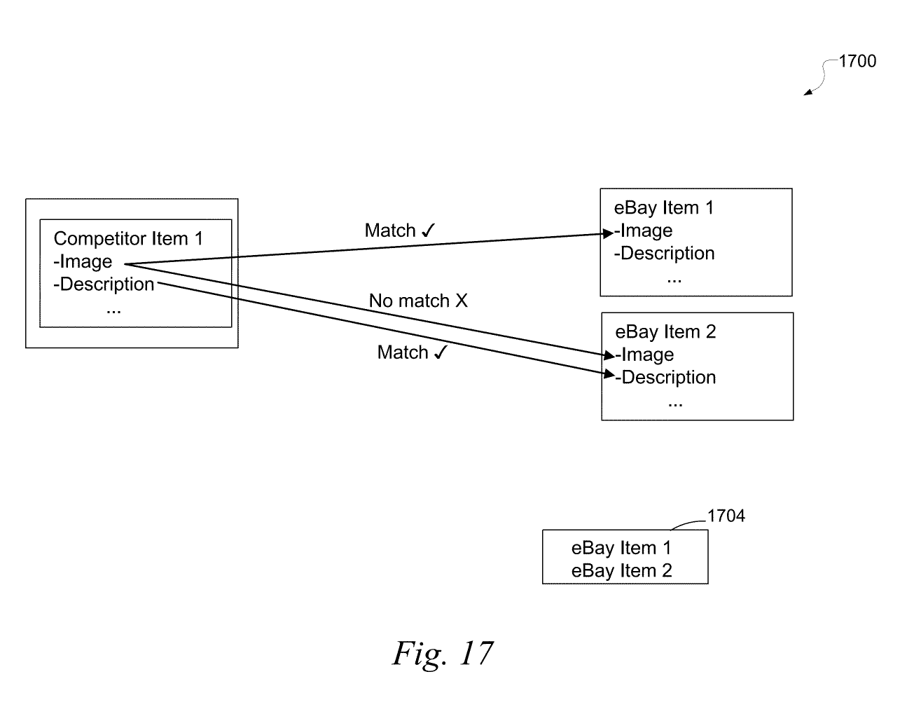

Turning now to FIGS. 16 and 17, according to various exemplary embodiments, the related item suggestion system 200 may crawl product listing pages on a competitor website, and match an external competitor product inventory to another product inventory of another retailer website (e.g., eBay). For example, FIG. 16 is a flowchart illustrating an example method 1500, according to various exemplary embodiments. The method 1500 may be performed at least in part by, for example, the related item suggestion system 200 illustrated in FIG. 2 (or an apparatus having similar modules, such as client machines 110 and 112 or application server 118 illustrated in FIG. 1). In operation 1601, the crawling module 202 crawls a product listing webpage associated with a retailer website, such as a competitor retailer website. As described elsewhere in this disclosure, the product listing webpage may describe a particular product offered for sale at the competitor retailer website, such as the XYZ smartphone. In operation 1602, the crawling module 202 extracts various information and/or attributes (e.g., title, description, image, price, competitor ID#, etc.) regarding the particular product from the product listing webpage that was crawled from the competitor website. In operation 1603, the determination module 204 performs a search for products in a second product inventory (e.g., eBay) with similar titles and other attributes, in order to find candidates for matching products in the second product inventory that match the specific product. For example, the determination module 204 may perform a domain specific search for products in a particular domain (e.g., eBay) that have similar titles to the particular product, by entering the search query terms “ebay: product title” into a search engine such as Google. The results may be classified as candidate matching products from the second inventory.

In operation 1604, the determination module 204 may expand the list of candidate matching products by finding any similar or related products in the second inventory that are related to the candidate matching products identified in operation 1603. For example, if the operation 1603 identifies a single candidate matching product that is the ABC smartphone, then in operation 1604, the determination module 204 may identify all items in the second product inventory (e.g., eBay) that are related to the ABC smartphone (e.g., similar items, items that were purchased by users that purchased the ABC smartphone, items that were viewed by users that viewed the ABC smartphone, and so on). Accordingly, the determination module 204 may expand the set of candidate matching products to now include the original ABC smartphone as well as all the items on the second product inventory (e.g., eBay) that are related to the ABC smartphone.

In operation 1605, the determination module 204 applies various similarity filters to the candidates matching items and the competitor product item (e.g., image similarity filter, title similarity filter, description similarity filter, price similarity filter, category similarity filter, etc.) in order to determine the actual matching product in the second product inventory (e.g., the matching eBay product).

Each of the aforementioned filters may correspond to a component of the determination module 204 configured to perform a comparison of a particular attribute, such as image, title, description, price, category, etc. For example, the image similarity filter may be configured to compare an image associated with the product from the competitor website (e.g., the XYZ smartphone on the competitor website), and the image associated with each of the candidate matching items in the second product inventory (e.g., the ABC smartphone or related items on eBay), using any known image similarity or image comparison techniques known to those skilled in the art. For example, the image similarity filter may generate color similarity scores, texture similarity scores, etc., based on the images being compared, and compare these scores to a predetermined threshold, in order to determine how similar the images are. As another example, the description similarity filter may be configured to compare the description associated with the product from the competitor website (e.g., the XYZ smartphone on the competitor website), and the descriptions associated with each of the candidate matching items in the second product inventory (e.g., the ABC smartphone or related items on eBay), using any known description similarity techniques (e.g., natural language processing, keyword processing, etc.) known to those skilled in the art. As another example, the price similarity filter may compare the difference (e.g., delta) between the price of the product from the competitor website (e.g., the XYZ smartphone on the competitor website), and the prices of each of the candidate matching items in the second product inventory (e.g., the ABC smartphone or related items on eBay), using any known statistical analysis techniques known to those skilled in the art. Similarly, the other image filters may compare various attributes of the product from the competitor website and the candidate matching products in order to determine how similar these products are. The output of each of the filters can be given a different weighting (e.g., based on the item title, the type of the item, the product category of the particular item, and so on). In some examples the image similarity may tend to be highly dispositive, and accordingly the output of the image similarity filter may be weighted higher than, for example, the output of the description similarity filter, which in turn may be weighted higher than the output of the price similarity filter, and so on.

In operation 1606 in FIG. 16, the determination module 204 determines a particular one of the candidate matching products that matches the particular product from the competitor website, based on the output of the filters. For example, if the output of the filters indicates that a particular one of the candidate matching products (e.g., the ABC smartphone in the eBay product inventory) is highly similar to the particular product from the competitor website (e.g., the XYZ smartphone in the competitor product inventory), the determination module 204 may determine that the ABC smartphone in the eBay product inventory matches the XYZ smartphone in the competitor product inventory. Accordingly, the determination module 204 is configured to identify an item in a product inventory (e.g., eBay product inventory) that matches a product item in another product inventory (e.g., competitor inventory).

The determination module 204 may repeat this operation for each product in all the available product listing webpages of the competitor website that may be crawled by the crawling module 202. Accordingly, each product in the inventory of the competitor website may be matched to a corresponding product in the product inventory of the second retailer website (e.g., eBay). Thus, a competitor's entire inventory may be matched to another product inventory using the embodiments described herein.

In some embodiments, if the related item suggestion system 200 receives a specification of a competitor's product, the system can show matching products from the second product inventory. For example, if the related item suggestion system 200 determines that the user is viewing a product on a competitor website, the related item suggestion system 200 may provide a price comparison between the competitor's product and the matching product in the second inventory (e.g., in the form of an advertisement). Similarly, if the user transmits a request to view a particular product on the second product inventory (e.g., eBay), the related item suggestion system 200 may provide a price comparison between this product and the matching product on the competitor website.

According to various exemplary embodiments, by matching a competitor's product inventory to the product inventory of a retailer website, the determination module 204 may determine if a price for an item on a retailer website (e.g., eBay.com) represents a “deal”, based on the price of the matching product on the competitor website. For example, if the eBay retailer website price for a given product is lower than a competitor price for the given product, then the eBay retailer website price for the given product may be considered a “deal”. In some embodiments, shipping costs may also be taken into account.

According to various exemplary embodiments, after the determination module 204 determines that a retailer website price for a given product item is a “deal”, the determination module 204 is configured to promote this deal in various ways. For example, the determination module 204 may expose advertisements to potential buyers indicating the eBay retailer website price for the product, the competitor's price for the product, the difference between the eBay retailer website price and the competitor's price, and so on. Such advertisements may be displayed via the web, such as on webpages associated with the retailer website (e.g., an item listing page for the given item) or on webpages associated with the competitor's website (e.g., an item listing page for the competitors item), or on any other websites, or in a mobile application. In some embodiments, the advertisements may be transmitted to users via text message, instant message, or email publications. For example, the determination module 204 may detect when users have viewed an item, saved an item, added an item to a wish list, etc., and yet the user has not purchased the item. Thereafter, a “Browse But Didn't Buy” email may be transmitted to these users, the e-mail indicating the various items that users viewed, as well as the comparative pricing information described in various embodiments. In some embodiments, advertisements may be promoted by displaying them higher (or in an otherwise more prominent position/location) in a list of search results or in a content feed of a retailer website.

In some embodiments, the determination module 204 may adjust the prices of products on a retailer website product inventory, based on the price of the matching product in the competitor inventory, in order to provide competitive pricing and deals. In some embodiments, the system 200 can provide pricing assistance to sellers. For example, when a seller tries to sell a particular product item on the retailer website, the determination module 204 may determine a price of the matching product on the competitor inventory, and suggest that the seller offer the product at a similar or lower price.

According to various exemplary embodiments, the related item suggestion system 200 can map a first category taxonomy (e.g., eBay category taxonomy) to a competitor category taxonomy. For example, by knowing how the competitor groups products in a particular product category, the related item suggestion system 200 may adjust the grouping of products in the second inventory to more closely match that of the competitor.

According to various exemplary embodiments, operation 1604 in FIG. 16 may be expanded to take into account items in the second inventory (e.g., eBay inventory) that not only match a competitor item, but that also match other items in the second product inventory, in order to enhance the overall matching process. For example, as illustrated in the schematic diagram 1700 in FIG. 17, competitor item 1 includes an image element, a description element, and other attributes. During the similarity checking process (in operation 1604 in FIG. 16), the determination module 204 may determine that the image of competitor item 1 matches the image of the eBay item 1, and thus eBay item 1 matches competitor item 1. However, it is possible the determination module 204 may also determine that the description of competitor item 1 matches the description of eBay item 2, and thus eBay item 2 also matches competitor item 1, even though the image of competitor item 1 does not match the image of eBay item 2. This means that eBay item 1 and eBay item 2 may be the same item, although there is diversity in the images and descriptions associated with this item. This may occur if, for example, the seller of eBay item 1 used a stock image for the item, but wrote their own unique description, whereas the seller of eBay item 2 used a stock description for the item, but added their own photo of the item. Accordingly, the determination module 204 may classify eBay item 1 and eBay item 2 as equivalent items and store them in association with each other in an equivalence item data structure 1704. Accordingly, the next time that a competitor item is being compared against eBay item 1, the attributes of the competitor item will also be compared against the attributes of all the appropriate equivalent eBay items (e.g., eBay item 1 and eBay item 2) in the data structure 1704 in order to increase the confidence that eBay item 1 is equivalent to eBay item 2, and to increase the confidence that a competitor item matches eBay item 1 and eBay item 2.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

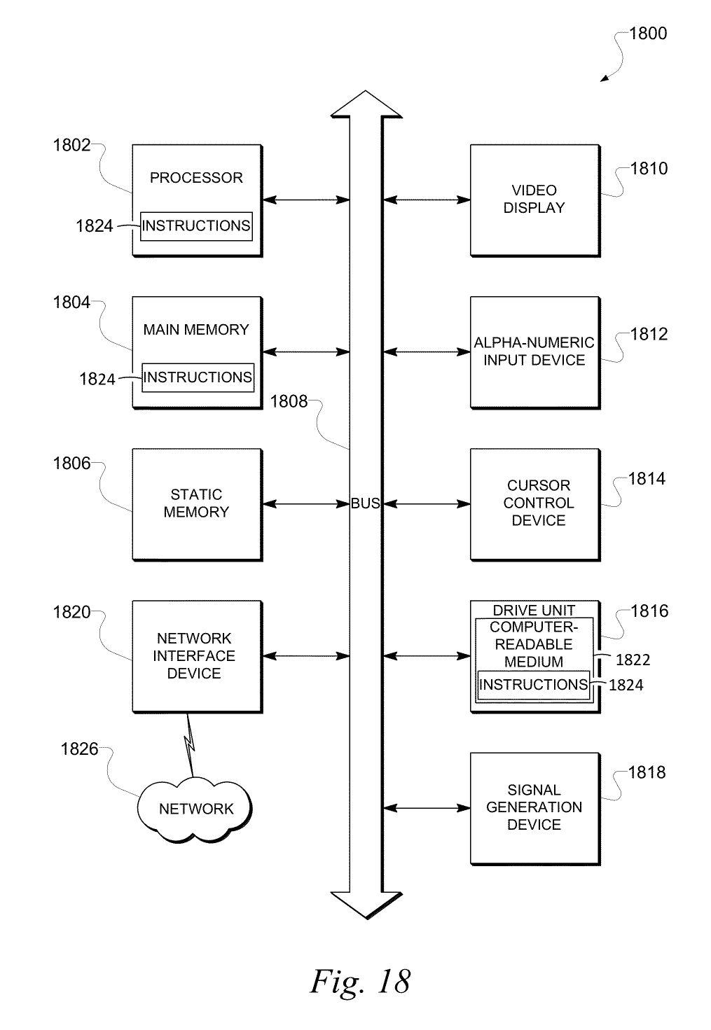

FIG. 18 is a block diagram of machine in the example form of a computer system 1800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard or a touch-sensitive display screen), a user interface (UI) navigation device 1814 (e.g., a mouse), a disk drive unit 1816, a signal generation device 1818 (e.g., a speaker) and a network interface device 1820.

### Machine-Readable Medium

The disk drive unit 1816 includes a machine-readable medium 1822 on which is stored one or more sets of instructions and data structures (e.g., software) 1824 embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media.

While the machine-readable medium 1822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
crawling a product listing webpage associated with a retailer website that describes a specific product, the specific product being included in a product inventory of the retailer website;
identifying, in the product listing webpage, product relations information associated with the specific product, the product relations information describing a first group of one or more additional products in the product inventory having a particular relationship with the specific product; and
transposing the product relations information to a second product inventory associated with a second retailer website by:
identifying a second product in the second product inventory that matches the specific product;
identifying a second group of one or more additional products in the second product inventory that matches the first group of one or more additional products; and
inferring that the second product has the particular relationship with the second group of one or more additional products.

2. The method of claim 1, wherein the product relations information is identified by:
accessing a list of predefined product relations keywords associated with various relationships; and
identifying one or more of the product relations keywords in the product listing webpage.

3. The method of claim 1, wherein the particular relationship described in the product relations information indicates that consumers who viewed the specific product also viewed one or more additional products in the first group.

4. The method of claim 1, wherein the particular relationship described in the product relations information indicates that consumers who purchased the specific product also purchased one or more additional products in the first group.

5. The method of claim 1, wherein the particular relationship described in the product relations information indicates that consumers who viewed the specific product also purchased one or more additional products in the first group.

6. The method of claim 1, wherein the particular relationship described in the product relations information indicates that the one or more additional products in the first group are accessories associated with the specific product.

7. The method of claim 1, further comprising:
receiving a request to view a product listing webpage of the second retailer website that is associated with the second product; and
displaying the product listing webpage for the second product, wherein the product listing webpage identifies the second group of one or more additional products and indicates that the second product has the particular relationship with the second group of one or more additional products.

8. The method of claim 1, further comprising:
causing a webpage to be displayed on a device, the webpage identifying the second product and indicating that the second product is related to at least one of the additional products in the second group.

9. The method of claim 1, further comprising:
transmitting a notification to a user, the notification identifying the second product and indicating that the second product is related to at least one of the additional products in the second group.

10. The method of claim 1, wherein the second product is identified by determining that the specific product and the second product have the same unique product identifier.

11. The method of claim 10, wherein the unique product identifier is at least one of a universal product code, an international article number, an international standard book number, or a global trade item number.

12. The method of claim 1, wherein the second product is identified by determining that the specific product and the second product have a similar brand name and the same manufacturer part number.

13. The method of claim 1, wherein the second product is identified by determining that the specific product and the second product have a similar product title.

14. The method of claim 1, wherein the second product is identified by determining that the specific product and the second product have a similar product image.

15. The method of claim 1, further comprising:
transposing product relations information for each product item in the product inventory of the retailer website to the second product inventory associated with a second retailer website.

16. An apparatus comprising:
a crawling module configured to:
crawl a product listing webpage associated with a retailer website that describes a specific product, the specific product being included in a product inventory of the retailer website; and
identify, in the product listing webpage, product relations information associated with the specific product, the product relations information describing a group of one or more additional products in the product inventory having a particular relationship with the specific product; and
a transposition module implemented by one or more processors and configured to transpose the product relations information to a second product inventory associated with a second retailer website by:
identifying a second product in the second product inventory that matches the specific product;
identifying a second group of one or more additional products in the second product inventory that matches the group of one or more additional products; and
inferring that the second product has the particular relationship with the second group of one or more additional products.

17. The apparatus of claim 16, wherein the product relations information is identified by:
accessing a list of predefined product relations keywords associated with various relationships; and
identifying one or more of the product relations keywords in the product listing webpage.

18. The apparatus of claim 16, wherein the transposition module is further configured to:
receive a request to view a product listing webpage of the second retailer website that is associated with the second product; and
display the product listing webpage for the second product, wherein the product listing webpage identifies the second group of one or more additional products and indicates that the second product has the particular relationship with the second group of one or more additional products.

19. A non-transitory machine-readable storage medium having embodied thereon instructions executable by one or more machines to perform operations comprising:
crawling a product listing webpage associated with a retailer website that describes a specific product, the specific product being included in a product inventory of the retailer website;
identifying, in the product listing webpage, product relations information associated with the specific product, the product relations information describing a group of one or more additional products in the product inventory having a particular relationship with the specific product; and
transposing the product relations information to a second product inventory associated with a second retailer website by:
identifying a second product in the second product inventory that matches the specific product;
identifying a second group of one or more additional products in the second product inventory that matches the group of one or more additional products; and
inferring that the second product has the particular relationship with the second group of one or more additional products.

20. The storage medium of claim 19, wherein the operations further comprise:
receiving a request to view a product listing webpage of the second retailer website that is associated with the second product; and
displaying the product listing webpage for the second product, wherein the product listing webpage identifies the second group of one or more additional products and indicates that the second product has the particular relationship with the second group of one or more additional products.
